(19) United States
(12) Patent Application Publication
(10) Pub. No.: US 2026/0300907 A1
(43) Pub. Date: Oct. 1, 2026

(54) NON-TRANSITORY COMPUTER-READABLE RECORDING MEDIUM AND INFORMATION PROCESSING DEVICE

(71) Applicant: Fujitsu Limited, Kawasaki-shi (JP)

(72) Inventors: Yoshie KIMURA, Kawasaki (JP); Jun TAKAHASHI, Kawasaki (JP)

(73) Assignee: Fujitsu Limited, Kawasaki-shi (JP)

(21) Appl. No.: 19/537,618

(22) Filed: Feb. 12, 2026

(30) Foreign Application Priority Data
Mar. 26, 2025 (JP) 2025-052118

(51) Int. Cl. G06Q 10/087; G06Q 30/06

(52) U.S. Cl. CPC G06Q 10/087; G06Q 30/06

(57) ABSTRACT

A non-transitory computer-readable recording medium has stored therein a detection program that causes a computer to execute a process including acquiring an image of a product shelf captured by a camera and a depth image of the product shelf, executing a first process, a second process, a third process and a fourth process and detecting whether the product in the product region is out of stock, based on the determination index of the first process, the determination index of the second process, the determination index of the third process, and the determination index of the fourth process.

### CROSS-REFERENCE TO RELATED APPLICATION

This application is based upon and claims the benefit of priority of the prior Japanese Patent Application No. 2025-052118, filed on Mar. 26, 2025, the entire contents of which are incorporated herein by reference.

### FIELD

The embodiments discussed herein are related to a computer-readable recording medium and the like.

### BACKGROUND

In a retail store, an employee may go around the store and visually confirm the state of a product shelf to determine whether or not to replenish the product. However, under such a method, employees perform checks in between their routine duties, thereby adding man-hours. In addition, there may be a case where an employee does not notice the out-of-stock and the out-of-stock is left for a long time, which may result in an opportunity loss of sales. Therefore, there is a demand for a technique for automatically determining the state of a product shelf.

For example, as conventional techniques for automatically determining a state of a product shelf, there are Prior Art 1 using a depth camera, Prior Art 2 using a depth camera, a convolutional neural network (CNN), and the like.

In Prior Art 1, a depth camera is installed in front of a shelf, and it is determined whether a product is out of stock on a product shelf based on depth information obtained from the depth camera. For example, in Prior Art 1, a product region obtained from the depth information is detected as a region of interest (ROI), and it is determined that a product is out of stock in a case where a surface of the ROI is gentle.

In Prior Art 2, a bounding box (Bbox) of a product is calculated by object recognition using a CNN, and the Bbox is superimposed on an estimation result (depth image) of a monocular depth camera. In Prior Art 2, a region where the Bbox is not superimposed in the region of the depth image is specified, and whether or not the region is an out-of-stock region is determined from an average value of depth information of the specified region.

Note that there is a technique called Multi-Modal Open-World Counting in addition to the above-described Prior Art 1 and Prior Art 2.
Patent Document 1: International Publication Pamphlet No. 2022/244176
Patent Document 2: International Publication Pamphlet No. 2022/024341
Patent Document 3: Japanese Laid-open Patent Publication No. 2021-33935
Patent Document 4: U.S. Pat. No. 10,949,799

However, in the above-described prior art, the introduction cost is high, and there is room for improvement.

For example, in Prior Art 1, depending on the shape of the product, it may be difficult to determine whether the product is out of stock only with the depth information obtained from the depth camera. Note that it is conceivable to use a high-accuracy depth camera; however, since the depth camera is installed for each product shelf, the cost increases, which is not realistic.

In Prior Art 2, it is determined whether the product is out of stock using both the CNN and the monocular depth camera. However, in order to accurately calculate the Bbox of the product, it is a prerequisite that training be performed using a large number of product images for pre-training. In a case where training is performed using only a small number of product images, the accuracy in calculating the Bbox of a different product having a similar shape decreases, making it difficult to determine whether the product is out of stock.

### SUMMARY

According to an aspect of an embodiment, a non-transitory computer-readable recording medium has stored therein a detection program that causes a computer to execute a process including acquiring an image of a product shelf captured by a camera and a depth image of the product shelf executing a first process of detecting a determination index indicating whether a product in a product region is out of stock, based on a result of segmentation executed on the product region of the image executing a second process of detecting a determination index indicating whether the product in the product region is out of stock, based on a depth in a horizontal direction of the product region of the depth image executing a third process of detecting a determination index indicating whether the product in the product region is out of stock, based on a result of edge extraction from the product region of the image executing a fourth process of detecting a determination index indicating whether the product in the product region is out of stock, based on a color of the product region of the image and detecting whether the product in the product region is out of stock, based on the determination index of the first process, the determination index of the second process, the determination index of the third process, and the determination index of the fourth process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a system according to the present example;

FIG. 2 is a diagram for illustrating a first process;

FIG. 3 is a diagram (1) for illustrating a second process;

FIG. 4 is a diagram (2) for illustrating the second process;

FIG. 5 is a diagram for illustrating a third process;

FIG. 6 is a functional block diagram illustrating a configuration of an information processing device according to the present example;

FIG. 7 is a flowchart illustrating a process procedure of the information processing device according to the present example; and

FIG. 8 is a diagram illustrating an example of a hardware configuration of a computer that implements functions similar to those of the information processing device according to examples.

### DESCRIPTION OF EMBODIMENTS

Preferred embodiments of the present invention will be explained with reference to accompanying drawings. Note that the present invention is not limited by the examples. In addition, the examples can be appropriately combined within a range without inconsistency.

### First Example

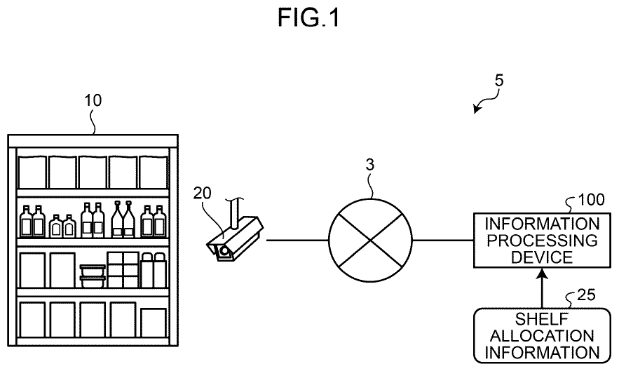

FIG. 1 is a diagram illustrating a system according to the present example. As illustrated in FIG. 1, the system 5 includes a camera 20 and an information processing device 100. The camera 20 and the information processing device 100 are connected to each other via a network 3.

The camera 20 is installed in front of a product shelf 10. The camera 20 captures an image of the product shelf 10, and transmits information of the captured image (video) to the information processing device 100. For example, the camera 20 may be an RGB-Depth (RGB-D) camera that captures both a normal red green blue (RGB) image and a depth image. In the following description, the RGB image is referred to as an input image. In addition, the input image and the depth image may be collectively referred to as image information.

The camera 20 transmits the image information to the information processing device 100 at a predetermined frame rate. A frame number may be assigned to each piece of image information.

Note that an administrator inputs shelf allocation information 25 to the information processing device 100. The shelf allocation information 25 is information for designating a region in which the same product is displayed among regions of the product shelf 10 included in the image information captured by the camera 20. In the following description, each region where the same product is displayed is referred to as a “product region”. For example, in a case where N types of products are displayed on the product shelf 10, N product regions are designated in the shelf allocation information 25.

The information processing device 100 executes first to fourth processes based on the image information acquired from the camera 20 and the shelf allocation information 25, and detects the out-of-stock of the product shelf 10 based on the execution result. Hereinafter, the first process, the second process, the third process, and the fourth process executed by the information processing device 100 will be described in order.

First, the first process executed by the information processing device 100 will be described. In the first process, segmentation (semantic segmentation) is performed on the input image, and the presence of the product is determined based on the area ratio of the product region and the number of segments.

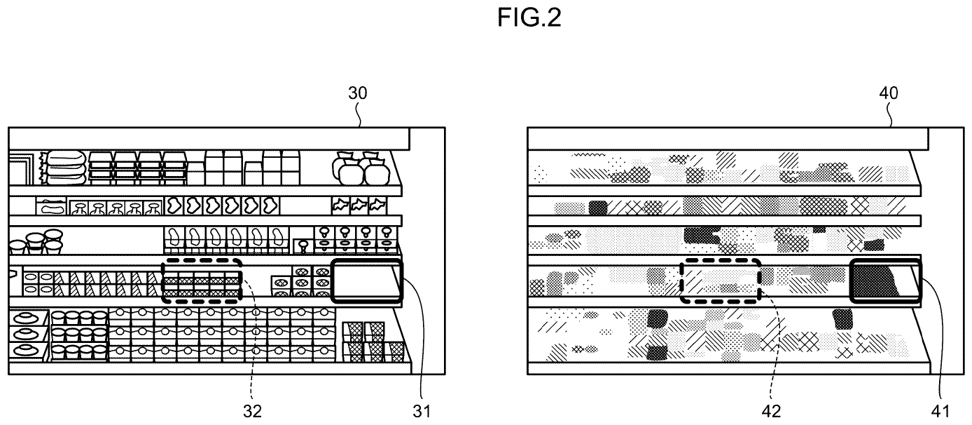

FIG. 2 is a diagram for illustrating the first process. The information processing device 100 executes segmentation on a product region 31 of an input image 30 to divide the product region 31 into segments. The information processing device 100 also executes segmentation on other product regions of the input image 30 for each product region to divide each product region into segments. As a result, a segmentation image 40 is generated. For example, the information processing device 100 may execute segmentation using fully convolutional networks (FCN) or the like.

For example, the product region of the segmentation image 40 corresponding to the product region 31 of the input image 30 is defined as a product region 41. The product region of the segmentation image 40 corresponding to a product region 32 of the input image 30 is defined as a product region 42. The information processing device 100 counts the number of segments in the product region, and in a case where the number of segments is less than a threshold value (for example, less than 2), it is determined that there is a high possibility that an out-of-stock has occurred in the product region.

For example, when the information processing device 100 counts the number of segments in the product region 41, since the number of segments is less than the threshold value, it determines that there is a high possibility that an out-of-stock has occurred in the product region 31. On the other hand, when the information processing device 100 counts the number of segments in the product region 42, since the number of segments is not less than the threshold value, it determines that there is a low possibility that an out-of-stock has occurred in the product region 32.

In addition, the information processing device 100 may select, from among the plurality of segments included in the product region of the segmentation image 40, the segment having the largest area, and determine that there is a high possibility that an out-of-stock has occurred in the product region in a case where the ratio of the selected segment occupying the product region is equal to or greater than a predetermined ratio (for example, 90% or more).

The information processing device 100 also executes the above process for other product regions of the segmentation image 40 and determines, for each product region, whether the possibility of an out-of-stock occurring is high or not.

Next, the second process executed by the information processing device 100 will be described. In the second process, the presence of the product is determined based on the continuous change in depth.

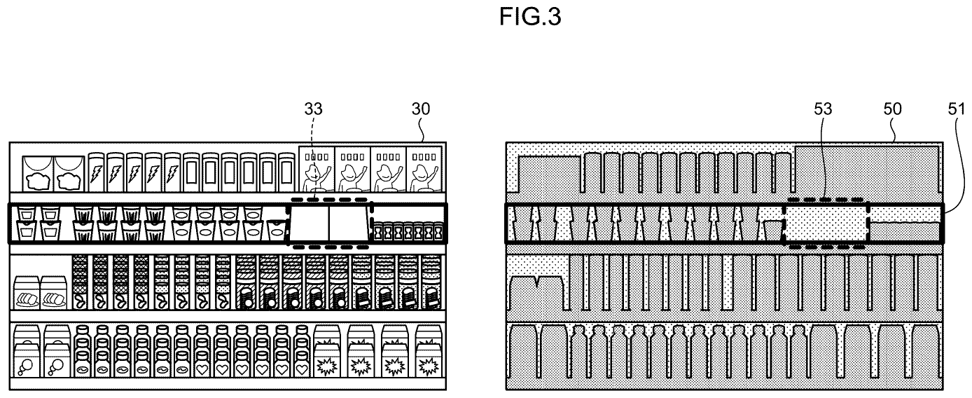

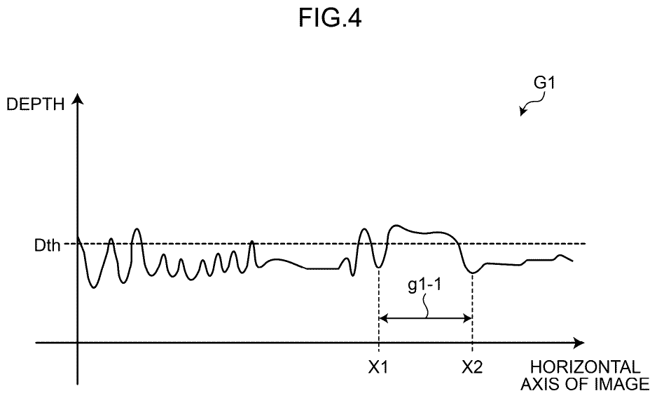

FIGS. 3 and 4 are diagrams for illustrating the second process. In FIG. 3, the information processing device 100 specifies the relationship between the coordinates of the horizontal axis of a region 51 of a depth image 50 and the depth. The region 51 includes a product region 53. It is assumed that the product region 53 corresponds to a product region 33 of the input image 30.

A graph G1 illustrated in FIG. 4 is a graph illustrating a relationship between the coordinate of the horizontal axis of the region 51 of the depth image 50 and the depth. The vertical axis of the graph G1 corresponds to the depth, and the horizontal axis corresponds to the coordinates of the horizontal axis of the region 51 of the depth image 50. A deeper depth indicates a far side.

For example, coordinates of the horizontal axis corresponding to the product region 53 are X1 to X2. For example, in a case where there are a predetermined ratio (for example, 80%) or more of portions where the depth is continuously equal to or greater than a threshold value Dth in the range of the coordinates X1 to X2, the information processing device 100 determines that there is a high possibility that an out-of-stock has occurred in the corresponding product region.

In the example illustrated in FIG. 4, in the range of the coordinates X1 to X2, a portion where the depth is continuously greater than or equal to the threshold value Dth is a portion g1-1, and there is a predetermined ratio or more. In this case, the information processing device 100 determines that there is a high possibility that an out-of-stock has occurred in the product region 33. The information processing device 100 may set the threshold value Dth in any manner. For example, a value obtained by adding a predetermined depth to the minimum depth of the depth of the graph G1 may be set as the threshold value Dth. As a result, a product region having a depth larger than that of a region where a product is present can be determined as a product region having a high possibility that an out-of-stock has occurred.

The information processing device 100 also executes the above process for the other product regions of the depth image 50, and determines whether the possibility that an out-of-stock has occurred is high or low for each product region.

Next, the third process executed by the information processing device 100 will be described. In the third process, the edge image is generated from the input image 30, and the presence of the product is determined according to whether the edge region exists at a predetermined ratio or more in the product region. For example, a product region having no product includes almost no edge.

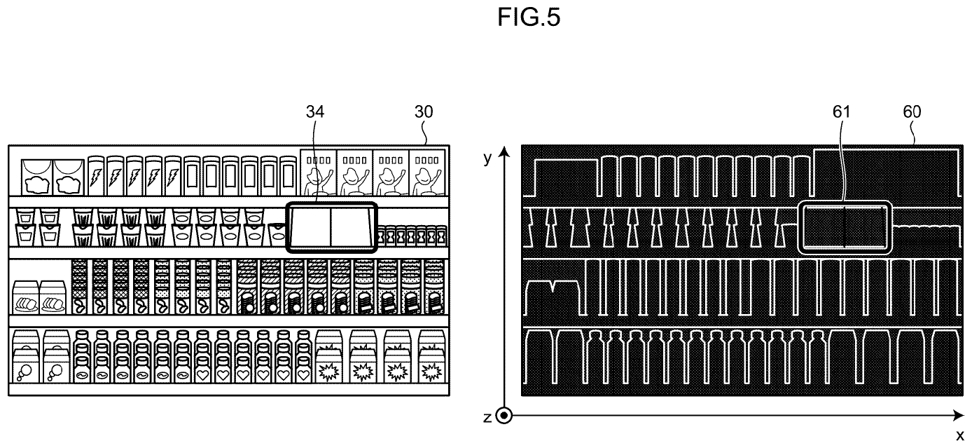

FIG. 5 is a diagram for illustrating the third process. The information processing device 100 generates an edge image 60 based on the input image 30. In a case where the ratio of the edge region (white region of the edge image 60) in the product region is equal to or greater than a predetermined ratio, the information processing device 100 determines that there is a high possibility that an out-of-stock has occurred in the corresponding product region.

For example, the information processing device 100 calculates the normal of each pixel by differentiating the depth set to each pixel of the depth image. In a case where the angle formed by the normal line of the pixel and the z axis of the camera coordinates is equal to or larger than the threshold value, the information processing device 100 sets the corresponding pixel to white (edge). On the other hand, in a case where the angle formed by the normal line of the pixel and the z axis of the camera coordinates is less than the threshold value, the information processing device 100 sets the corresponding pixel to black. The information processing device 100 generates the edge image 60 obtained by binarizing the input image 30 by repeatedly executing the above process for each pixel. In a case where the camera 20 is installed in front of the product shelf 10, the horizontal direction of the edge image 60 is the x-axis, the vertical direction is the y-axis, and the direction of the camera 20 is the z-axis.

For example, the product region of the edge image 60 corresponding to the product region 34 of the input image 30 is defined as a product region 61. Since the ratio of the edge region in the product region 61 is less than the predetermined ratio, the information processing device 100 determines that there is a high possibility that an out-of-stock has occurred in the product region 34.

The information processing device 100 also executes the above process for the other product regions of the edge image 60, and determines whether the possibility that an out-of-stock has occurred is high for each product region.

Next, the fourth process executed by the information processing device 100 will be described. In the fourth process, the color feature amount is extracted from the product region of the input image 30, and the presence of the product is determined. In general, the shelf itself on which the product is placed has a uniform similar color, and the product often has a colorful color in order to stimulate the desire of purchase.

For example, the information processing device 100 converts each pixel of the product region of the input image 30 into a value of a hue saturation value (HSV) color space. The information processing device 100 calculates the variance based on the value of the HSV color space of each pixel in the product region, and determines that there is a high possibility that an out-of-stock has occurred in the product region in a case where the variance is less than a threshold value. On the other hand, in a case where the variance is less than the threshold value, the information processing device 100 determines that there is a low possibility that an out-of-stock has occurred in the product region.

The information processing device 100 also repeatedly executes the above process for the other product regions of the input image, and determines whether the possibility that an out-of-stock has occurred is high for each product region.

The information processing device 100 executes each of the first process to the fourth process, and finally detects whether an out-of-stock has occurred in the product region using the results of the first process to the fourth process. For example, the information processing device 100 detects whether an out-of-stock has occurred in the product region by a first detection process or a second detection process. An administrator or the like sets in advance which detection process of the first detection process and the second detection process the information processing device 100 uses. Furthermore, the administrator may set the information processing device 100 to execute both the first detection process and the second detection process.

First, the first detection process will be described. The information processing device 100 executes processes in order of the first process, the second process, the third process, and the fourth process, and detects that a product in a certain product region is out-of-stock in a case where it is determined that there is a high possibility that an out-of-stock has occurred in any process for the certain product region.

For example, in a case where it is determined that there is a high possibility that an out-of-stock has occurred in the product region 31 in the first process described with reference to FIG. 2, the information processing device 100 detects that the product in the product region 31 is out of stock regardless of the determination results of the second process, the third process, and the fourth process that follow. In a case where the information processing device 100 determines that there is a high possibility that an out-of-stock has occurred in the product region 31, the second process, the third process, and the fourth process may be skipped for the product region 31.

Note that, in the above description, a case where the first process, the second process, the third process, and the fourth process are performed in this order in the first detection process has been described. However, the process may be performed in the order of higher priority according to a priority set in advance.

Next, the second detection process will be described. The information processing device 100 calculates an out-of-stock score for a certain product region based on the determination results of the first process, the second process, the third process, and the fourth process for the certain product region. For example, the information processing device 100 calculates an out-of-stock score for a certain product region based on Formula (1), and detects that a product in the certain product region is out of stock in a case where the out-of-stock score is a predetermined score or more.

$$Out - of - stock score = w 1 \times ( value corresponding to determination result of first process ) + w 2 \times ( value corresponding to determination result of second process ) + w 3 \times ( value corresponding to determination result of third process ) + w 4 \times ( value corresponding to determination result of fourth process ) \qquad ( 1 )$$

In Formula (1), w1, w2, w3, and w4 are weights set in advance. A larger weight is set for a process with a higher priority. In order to accurately detect an out-of-stock, tuning of w1, w2, w3, and w4 may be performed using a predetermined well-known technique.

The value according to the determination result of the first process is, for example, “1” in a case where a certain product region is determined as a product region having a high possibility of occurrence of an out-of-stock by the first process, and is “0” in a case where the certain product region is determined as a product region having a low possibility of occurrence of an out-of-stock.

The value according to the determination result of the second process is, for example, “1” in a case where a certain product region is determined as a product region having a high possibility of occurrence of an out-of-stock by the second process, and is “0” in a case where the certain product region is determined as a product region having a low possibility of occurrence of an out-of-stock.

The value according to the determination result of the third process is, for example, “1” in a case where a certain product region is determined as a product region having a high possibility of occurrence of an out-of-stock by the third process, and is “0” in a case where the certain product region is determined as a product region having a low possibility of occurrence of an out-of-stock.

The value according to the determination result of the fourth process is, for example, “1” in a case where a certain product region is determined as a product region having a high possibility of occurrence of an out-of-stock by the fourth process, and is “0” in a case where the certain product region is determined as a product region having a low possibility of occurrence of an out-of-stock.

The information processing device 100 executes the first detection process and the second detection process described above for each product region set in the shelf allocation information 25, and outputs information on the product region in which an out-of-stock has been detected. For example, the information processing device 100 may output information of a product region where an out-of-stock is detected to a terminal device used by an administrator or the like.

Here, in a case where an obstacle such as a person or a shopping cart is present between the product shelf 10 and the camera 20, the detection accuracy of the out-of-stock with respect to the product region may be deteriorated. For this reason, the information processing device 100 may execute the following obstacle detection process and temporarily stop the process of detecting the out-of-stock from the product region while an obstacle is detected.

An example of the obstacle detection process executed by the information processing device 100 will be described. The information processing device 100 divides the depth image into an upper image and a lower image, and divides the lower image into a plurality of blocks. The information processing device 100 calculates an average value of the depths of the blocks. The information processing device 100 calculates a difference between the blocks in the horizontal axis direction (horizontal direction), and determines that an obstacle is present (detects the obstacle) when there is a difference equal to or greater than a threshold value. The threshold value to be compared with the difference may be appropriately tuned by an administrator or the like.

As described above, the information processing device 100 according to the present example executes the first process, the second process, the third process, and the fourth process, determines whether there is a high possibility that the out-of-stock has occurred in the product region, and comprehensively detects the out-of-stock in the product region. The information processing device 100 can detect a product region where an out-of-stock condition has occurred without performing preliminary training using an enormous number of product images as described in the prior art.

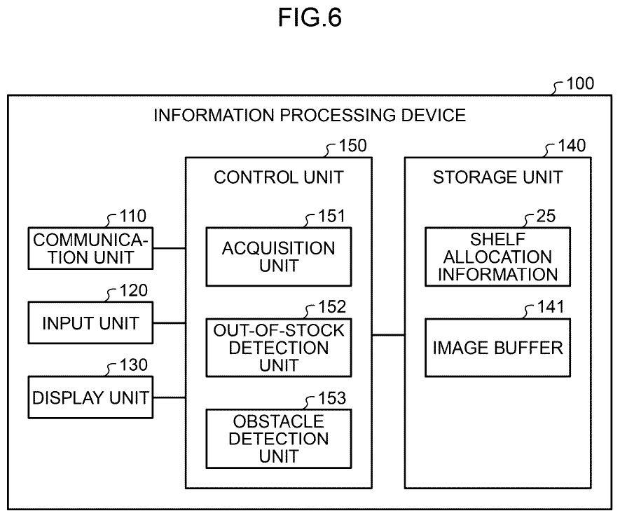

Next, a configuration example of the information processing device 100 according to the present example will be described. FIG. 6 is a functional block diagram illustrating a configuration of an information processing device according to the present example. As illustrated in FIG. 6, the information processing device 100 includes a communication unit 110, an input unit 120, a display unit 130, a storage unit 140, and a control unit 150.

The communication unit 110 executes data communication with the camera 10 via the network 3. For example, the communication unit 110 receives image information from the camera 20.

The input unit 120 is an input device that inputs various types of information to the control unit 150 of the information processing device 100. The administrator or the like may operate the input unit 120 to input and update the shelf allocation information 25.

The display unit 130 is a display device that displays information output from the control unit 150. For example, the display unit 130 may display information on a product region where an out-of-stock has occurred.

The storage unit 140 includes the shelf allocation information 25 and an image buffer 141. The storage unit 140 is a memory or the like.

The shelf allocation information 25 is information for designating a product region in which the same product is displayed among regions of the product shelf 10 included in the image information captured by the camera 20. For example, information on a plurality of product regions is set in the shelf allocation information 25, and coordinates indicating a range of the product region and a product name are associated with the information on each product region.

The image buffer 141 is a buffer that stores image information acquired from the camera 20. As described above, the image information includes the input image and the depth image. A frame number for identifying the image information may be assigned to the image information stored in the image buffer 141.

The control unit 150 includes an acquisition unit 151, an out-of-stock detection unit 152, and an obstacle detection unit 153. The control unit 150 is a central processing unit (CPU), a graphics processing unit (GPU), or the like.

The acquisition unit 151 acquires image information from the camera 20, and stores the acquired image information in the image buffer 141. In addition, the acquisition unit 151 acquires the shelf allocation information 25 from the input unit 120 and stores the information in the storage unit 140.

The out-of-stock detection unit 152 acquires shelf allocation information 25 and image information of the image buffer 141, and detects an out-of-stock for each product region of the product shelf 20. The out-of-stock detection unit 152 may cause the display unit 130 to display the detection result or may transmit the detection result to a designated terminal device.

For example, the out-of-stock detection unit 152 executes the first process, the second process, the third process, and the fourth process. After executing the first process, the second process, the third process, and the fourth process, the out-of-stock detection unit 152 executes the first detection process or the second detection process to detect the out-of-stock in each product region.

The description regarding the first process, the second process, the third process, and the fourth process is similar to the description regarding the first process, the second process, the third process, and the fourth process described above. The description regarding the first detection process and the second detection process is similar to the description regarding the first detection process and the second detection process described above.

With respect to the image information in which the obstacle is detected by the obstacle detection unit 153, the out-of-stock detection unit 152 temporarily stops the process of detecting the out-of-stock of each product region. For the image information in which the obstacle is detected, the out-of-stock detection unit 152 may execute the process of detecting the out-of-stock only in the product region located on the upper side using the image information on the upper side.

In a case where the out-of-stock is detected in a certain product region, the out-of-stock detection unit 152 may specify a product name of the certain product region based on the shelf allocation information 25 and cause the display unit 130 to display the product name as information of the product region in which the out-of-stock is detected.

The obstacle detection unit 153 detects whether an obstacle is present between the product shelf 10 and the camera 20 based on the image information. The process executed by the obstacle detection unit 153 is similar to the obstacle detection process described above. For example, in a case of detecting the presence of an obstacle based on certain image information, the obstacle detection unit 153 outputs a frame number of the certain image information and information indicating that the obstacle has been detected in the image information of the frame number to the out-of-stock detection unit 152.

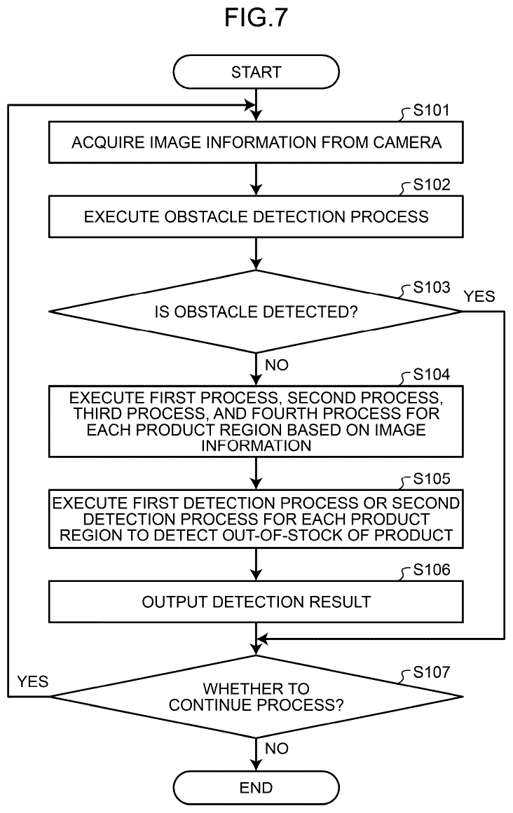

Next, an example of process procedure of the information processing device 100 according to the present example will be described. FIG. 7 is a flowchart illustrating a process procedure of the information processing device according to the present example. As illustrated in FIG. 7, the acquisition unit 151 of the information processing device 100 acquires image information from the camera 20 (Step S101).

The obstacle detection unit 153 of the information processing device 100 executes an obstacle detection process (Step S102). In a case where no obstacle is detected (Step S103, No), the information processing device 100 proceeds to Step S104. On the other hand, in a case where the obstacle is detected (Step S103, Yes), the information processing device 100 proceeds to Step S107.

The out-of-stock detection unit 152 of the information processing device 100 executes the first process, the second process, the third process, and the fourth process for each product region based on the image information (Step S104). The out-of-stock detection unit 152 executes the first detection process or the second detection process for each product region based on the results of the first process, the second process, the third process, and the fourth process, and detects an out-of-stock of a product (Step S105).

The out-of-stock detection unit 152 outputs the detection result to the display unit 130 (Step S106). In a case where the process is continued (Step S107, Yes), the information processing device 100 proceeds to step S101. On the other hand, in a case where the process is not continued (Step S107, No), the information processing device 100 ends the process.

Next, an effect of the information processing device 100 according to the present example will be described. The information processing device 100 executes the first process, the second process, the third process, and the fourth process, determines whether there is a high possibility that the out-of-stock has occurred in the product region, and comprehensively detects the out-of-stock in the product region. The information processing device 100 can detect a product region where an out-of-stock condition has occurred without performing preliminary training using an enormous number of product images as described in the prior art.

The information processing device 100 determines whether the product in the product region is out of stock based on a result of weighting each of the determination result of the first process, the determination result of the second process, the determination result of the third process, and the determination result of the fourth process. As a result, it is possible to determine whether the product is out of stock with emphasis on the determination result of the important process.

The information processing device 100 determines whether an obstacle is present between the product shelf 10 and the camera 20, and further uses the determination result to detect whether the product in the product region is out of stock. As a result, it is possible to determine whether the product is out of stock while excluding the influence of obstacles.

As the first process, the information processing device 100 determines whether the product in the product region is out of stock based on the number of segments included in the product region or the ratio of the segments occupying the product region. This makes it possible to determine whether there is a high possibility that an out-of-stock has occurred in the product region from the viewpoint of increasing the segmentation area or increasing the number of segments in a case where there is no product.

As the second process, the information processing device 100 determines whether the product in the product region is out of stock based on the ratio of the region where the depth in the horizontal direction in the product region is continuously equal to or greater than the threshold value to the product region. As a result, it is possible to determine whether there is a high possibility that an out-of-stock has occurred in the product region from the viewpoint that a depth becomes larger than that in a region where the product exists and a portion where the depth becomes larger is continuously observed when the product does not exist.

As the third process, the information processing device 100 determines whether the product in the product region is out of stock based on the ratio of the edges occupying the product region. As a result, it is possible to determine whether there is a high possibility that the out-of-stock has occurred in the product region using the edge.

As the fourth process, the information processing device 100 calculates the variance of the color values for each pixel in the product region, and determines whether the product in the product region is out of stock based on the variance. As a result, it is possible to determine whether there is a high possibility that the out-of-stock has occurred in the product region using the fact that the shelf itself on which the product is placed has a uniform similar color and the product often has a colorful color.

### Second Example

Here, the information processing device 100 can execute any two or more processes of the first process, the second process, the third process, and the fourth process, and detect whether the product in the product region is out of stock based on the determination results of the two or more processes. Note that, here, a process of executing any two of the first process, the second process, the third process, and the fourth process and detecting whether the product in the product region is out of stock based on the determination results of the two processes will be described.

First, the information processing device 100 acquires an image of a product shelf captured by a camera and a depth image of the product shelf. Next, the information processing device 100 executes any two processes of the first process of detecting the determination index as to whether a product in the product region is out of stock based on a result of executing segmentation on the product region of the image, a second process of detecting a determination index as to whether a product in the product region is out of stock based on a depth in a horizontal direction of the product region of the depth image, a third process of detecting a determination index as to whether a product in the product region is out of stock based on a result of extracting an edge from the product region of the image, and a fourth process of detecting a determination index as to whether a product in the product region is out of stock based on a color of the product region of the image. Then, the information processing device 100 detects whether the product in the product region is out of stock based on the respective determination indexes of the executed two processes. Thereafter, the information processing device 100 notifies the terminal that the product is out of stock.

Here, a process example of proposing a measure using the AI agent will be described. The information processing device 100 can propose a measure using an AI agent. When giving the goal to the AI agent, the information processing device 100 executes a task in which the AI agent generates a task for achieving the goal, collects information for causing the language model to execute the generated task, and inputs the collected information to the language model.

For example, when giving a goal, the AI agent can generate a task for achieving the goal, collect information for causing the language model to execute the generated task, and cause the language model to execute the task. The AI agent generates a measure to be applied to the store, and the AI agent notifies the terminal of the generated measure.

More specifically, when a goal is given to the AI agent, the AI agent causes the language model to generate a task for achieving the goal and executes the generated task. For example, the AI agent aims to present measures to be applied to the store.

First, the AI agent stores the out-of-stock result indicating whether the product in the product region is out of stock in the storage unit. Next, the AI agent collects the out-of-stock result of the product from the storage unit, and presents a measure to be applied to the store based on the collected out-of-stock result of the product. For example, the AI agent collects, from the storage unit, the fact that a product A is out of stock from among the plurality of products, and inputs, to the language model, a prompt incorporating the fact that the product A is out of stock and the fact that measures to be applied to the store are requested, thereby generating a measure against the missing product A as a measure to be applied to the store. Then, the information processing device 100 can cause the AI agent to propose the generated measure. For example, since the product A was out of stock, the information processing device 100 can make a proposal to display the product A. As a result, the information processing device 100 can suppress hallucinations of the AI agent and appropriately support application of the measures.

### Hardware Configuration

Next, an example of a hardware configuration of a computer that implements functions similar to those of the information processing device 100 described in each of the above examples will be sequentially described.

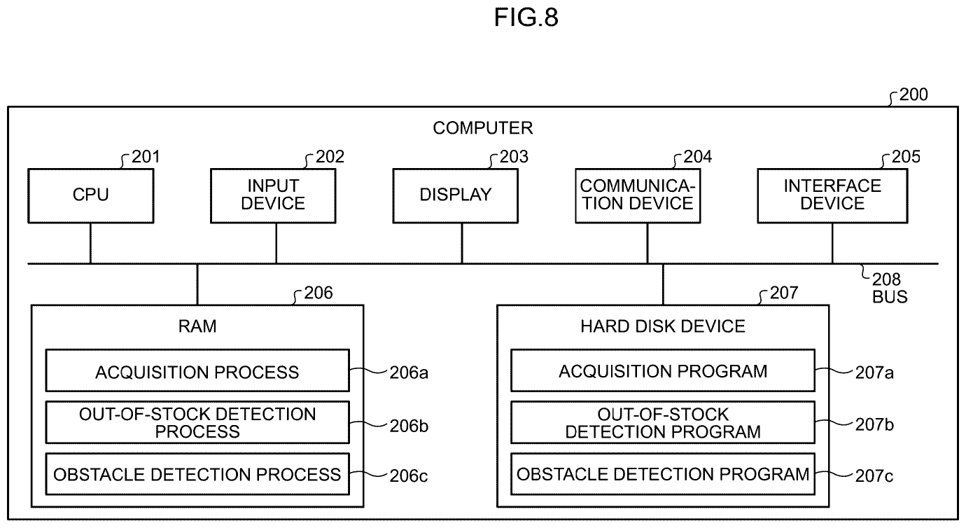

FIG. 8 is a diagram illustrating an example of a hardware configuration of a computer that implements functions similar to those of the information processing device according to examples. As illustrated in FIG. 8, a computer 200 includes a CPU 201 that executes various types of arithmetic processing, an input device 202 that receives an input of data from a user, and a display 203. Furthermore, the computer 200 includes a communication device 204 that exchanges data with the camera 20 and the like via a wired or wireless network, and an interface device 205. In addition, the computer 200 includes a RAM 206 that temporarily stores various types of information and a hard disk device 207. Each of the devices 201 to 207 is connected to a bus 208.

The hard disk device 207 includes an acquisition program 207a, an out-of-stock detection program 207b, and an obstacle detection program 207c. The CPU 201 reads the programs 207a to 207c and develops the programs in the RAM 206.

The acquisition program 207a functions as an acquisition process 206a. The out-of-stock detection program 207b functions as an out-of-stock detection process 206b. The obstacle detection program 207c functions as an obstacle detection process 206c.

The process of the acquisition process 206a corresponds to the process of the acquisition unit 151. The process of the out-of-stock detection process 206b corresponds to the process of the out-of-stock detection unit 152. The process of the obstacle detection process 206c corresponds to the process of the obstacle detection unit 153.

Each of the programs 207a to 207c does not necessarily need to be stored in the hard disk drive 207 from the beginning. For example, each program is stored in a “portable physical medium” such as a flexible disk (FD), a CD-ROM, a DVD, a magneto-optical disk, or an IC card inserted into the computer 200. Then, the computer 200 may read and execute the programs 207a to 207c.

It is possible to suppress the introduction cost and detect an out-of-stock of the product.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is

1. A non-transitory computer-readable recording medium having stored therein a detection program that causes a computer to execute a process comprising:
acquiring an image of a product shelf captured by a camera and a depth image of the product shelf;
executing a first process of detecting a determination index indicating whether a product in a product region is out of stock, based on a result of segmentation executed on the product region of the image;
executing a second process of detecting a determination index indicating whether the product in the product region is out of stock, based on a depth in a horizontal direction of the product region of the depth image;
executing a third process of detecting a determination index indicating whether the product in the product region is out of stock, based on a result of edge extraction from the product region of the image;
executing a fourth process of detecting a determination index indicating whether the product in the product region is out of stock, based on a color of the product region of the image; and
detecting whether the product in the product region is out of stock, based on the determination index of the first process, the determination index of the second process, the determination index of the third process, and the determination index of the fourth process.

2. The non-transitory computer-readable recording medium according to claim 1, wherein the process further includes determining whether the product in the product region is out of stock based on results obtained by weighting the determination index of the first process, the determination index of the second process, the determination index of the third process, and the determination index of the fourth process, respectively.

3. The non-transitory computer-readable recording medium according to claim 1, wherein the process further includes determining, based on the depth image, whether an obstacle exists between the product shelf and a camera, and the detecting process further detects whether the product in the product region is out of stock using a determination result of the determining.

4. The non-transitory computer-readable recording medium according to claim 1, wherein the first process determines whether the product in the product region is out of stock based on a number of segments included in the product region or a ratio of the segments occupying the product region.

5. The non-transitory computer-readable recording medium according to claim 1, wherein the second process determines whether the product in the product region is out of stock based on a ratio of a region, in which a depth in a horizontal direction in the product region continuously becomes equal to or greater than a threshold value, occupying the product region.

6. The non-transitory computer-readable recording medium according to claim 1, wherein the third process determines whether the product in the product region is out of stock based on a ratio of edges occupying the product region.

7. The non-transitory computer-readable recording medium according to claim 1, wherein the fourth process calculates a variance of color values for respective pixels in the product region, and determines whether the product in the product region is out of stock based on the variance.

8. A non-transitory computer-readable recording medium having stored therein a detection program that causes a computer to execute a process comprising:
acquiring an image of a product shelf captured by a camera and a depth image of the product shelf;
executing any two among a first process, a second process, a third process, and a fourth process, the first process detecting a determination index indicating whether a product in a product region is out of stock based on a result of segmentation executed on the product region of the image, the second process detecting a determination index indicating whether the product in the product region is out of stock based on a depth in a horizontal direction of the product region of the depth image, the third process detecting a determination index indicating whether the product in the product region is out of stock based on a result of edge extraction from the product region of the image, and the fourth process detecting a determination index indicating whether the product in the product region is out of stock based on a color of the product region of the image; and
detecting whether the product in the product region is out of stock based on the determination indexes of the executed two processes.

9. The non-transitory computer-readable recording medium according to claim 8, wherein the process further includes
when a goal is given to an AI agent, generating a task for achieving the goal by the AI agent, collecting information for causing a language model to execute the generated task, and executing a task of inputting the collected information to the language model, and
collecting an out-of-stock result indicating an out-of-stock of the product in the detected product region, generating a measure to be applied to a store by inputting to the language model, a prompt incorporating the collected out-of-stock result, and notifying a terminal of the generated measure by the AI agent.

10. An information processing device comprising:
a memory; and
a processor coupled to the memory and configured to:
acquire an image of a product shelf captured by a camera and a depth image of the product shelf,
execute a first process of detecting a determination index indicating whether a product in a product region is out of stock, based on a result of segmentation executed on the product region of the image,
execute a second process of detecting a determination index indicating whether the product in the product region is out of stock, based on a depth in a horizontal direction of the product region of the depth image,
execute a third process of detecting a determination index indicating whether the product in the product region is out of stock, based on a result of edge extraction from the product region of the image,
execute a fourth process of detecting a determination index indicating whether the product in the product region is out of stock, based on a color of the product region of the image, and
detect whether the product in the product region is out of stock, based on the determination index of the first process, the determination index of the second process, the determination index of the third process, and the determination index of the fourth process.

11. The information processing device according to claim 10, wherein the processor is further configured to determine whether the product in the product region is out of stock based on results obtained by weighting the determination index of the first process, the determination index of the second process, the determination index of the third process, and the determination index of the fourth process, respectively.

12. The information processing device according to claim 10, wherein the processor is further configured to determine, based on the depth image, whether an obstacle exists between the product shelf and a camera, and the detecting process further detects whether the product in the product region is out of stock using a determination result of the determining.

13. The information processing device according to claim 10, wherein the first process determines whether the product in the product region is out of stock based on a number of segments included in the product region or a ratio of the segments occupying the product region.

14. The information processing device according to claim 10, wherein the second process determines whether the product in the product region is out of stock based on a ratio of a region, in which a depth in a horizontal direction in the product region continuously becomes equal to or greater than a threshold value, occupying the product region.

15. The information processing device according to claim 10, wherein the third process determines whether the product in the product region is out of stock based on a ratio of edges occupying the product region.

16. The information processing device according to claim 10, wherein the fourth process calculates a variance of color values for respective pixels in the product region, and determines whether the product in the product region is out of stock based on the variance.
